(19) United States
(12) Patent Application Publication
(10) Pub. No.: US 2008/0152848 A1
(43) Pub. Date: Jun. 26, 2008

(54) Insulating Glass Pane and Method of Production Thereof

(76) Inventor: Karl Lenhardt, Bad Liebenzell (DE)

Correspondence Address: Orum & Roth, 53 W. Jackson Blvd., Chicago, IL, 60604-3606, US

(21) Appl. No.: 11/795,535

(22) PCT Filed: Jan. 18, 2006
(86) PCT No.: PCT/EP06/00411

§ 371 Date: Sep. 10, 2007

(30) Foreign Application Priority Data
Jan. 18, 2005 (JP) 10 2005 002 488.2
May 18, 2005 (JP) 10 2005 023 506.9

(51) Int. Cl. E06B 3/66; E06B 3/673; E06B 3/663

(52) U.S. Cl. 428/34; 156/107

(57) ABSTRACT

The invention relates to an insulating glass pane, in which two separate glass panes (2, 3) are held at a distance from one another by a spacer (4), which consists of a strip and which has an inner side (12), and outer side (6) and two flanks (11). A drying agent is provided in conjunction with the spacer (4), and a gap is provided on both sides of the spacer (4) between the spacer and both glass panes (2, 3). This gap is sealed by a primary sealing compound (19) that adheres to the spacer (4) and to the glass panes (2, 3). This invention provides that a compound (18), which contains a drying agent is supplies to the primary sealing compound (19) that seals both gaps and, afterwards, to the side (12) of the spacer (4) (also referred to as inner side (12) hereafter), this side facing the inner space (17) of the insulating glass pane. Said compound (18) is applies so that it covers the inner side (12), that is, as long as the inner side is not already covered by the primary sealing compound (19).

The present invention is directed at improving an insulating glass pane having the features defined in the preamble of Claim 1. Such an insulating glass pane is the object of DE 10 2004 020 883.2.

An insulating glass pane of that kind comprises two separate glass panels that are held at a distance one from another by a spacer which consists of a sectional bar to which they are bonded by a sealing compound, hereinafter also described as primary sealing compound. The primary sealing compound bonds the two flanks of the spacer tightly to the two glass panels, thereby sealing the inner space of the insulating glass pane from penetrating water vapor and—in the case of insulating glass panes filled with a heavy gas—from losses of heavy gas, if any. The primary sealing compound most commonly used is polyisobutylene (butyl caoutchouc) by means of which efficient sealing from diffusion of water vapor can be achieved. Polyisobutylenes are thermoplastic, adhesive substances. In addition to their function of sealing the inner space of the insulating glass pane, they further serve, during assembly of the insulating glass pane, to provide a temporary bond between the spacer and the two glass panels to which the spacer is bonded along the panel edges.

Due to their thermoplastic property polyisobutylenes are, however, not suited for producing a durable, firm mechanical bond between the glass panels of the insulating glass pane. Rather, that bond can be achieved by a curable secondary sealing compound which is applied between the glass panels either to cover the entire outside of the spacer, extending without any interruption from the one glass panel to the other glass panel, or by forming two ropes of the secondary sealing compound, one bonding one of the glass panels to the spacer and the other one bonding the other glass panel to the spacer, while leaving the outside of the spacer uncovered in full or in part. Commonly used as secondary sealing compounds are curable two-component plastic materials, especially polysulfides, polyurethanes and silicones.

In the case of the insulating glass pane being the object of DE 10 2004 020 883, a compound containing a drying agent, especially molecular sieves (zeolites), is applied on the inside of the spacer. Preferably, that compound is applied immediately adjacent and in intimate contact with the primary sealing compound that seals both gaps between the glass panels and the spacer. The compound containing a drying agent absorbs and binds humidity that may be present in the inner space of the insulating glass pane, and intercepts and binds any water vapor that may diffuse into the compound from the outside. The compound preferably covers the side of the spacer facing the inner space of the insulating glass pane, i.e. where it is not already covered by primary sealing compound. The primary sealing compound may be followed, toward the outside, preferably immediately adjacent the compound, by a curable secondary sealing compound that bonds the two glass panels one to the other directly or indirectly, thereby forming a durable, mechanically firm bond between the glass panels. In the case of a direct bond, the secondary sealing compound extends from the one glass panel over the outside of the spacer to the other glass panel. Indirect bonding can be effected by two separate ropes of secondary sealing compound, one bonding the one glass panel, the other one bonding the other glass panel to the spacer.

A secondary sealing compound is not needed if the primary sealing compound is selected to ensure that it will be capable of providing the required permanent mechanical bond between the glass panels. Such a sealing compound, that meets the demands placed on both the primary and the secondary sealing compound, can be obtained for example by mixing a thermoplastic component, that provides good sealing from water vapor diffusion, with a permanently curing component that provides the firm mechanical bond.

It has been known to subdivide the inner space of the insulating glass pane by one or more muntins in order to give a window the appearance of a muntin window. With respect to insulating glass panes, the spacers of which are formed from metallic hollow-section bars whose flanks are coated with a sealing compound and are bonded in this way to the two glass panels of the insulating glass pane, it has been known to mechanically bond a prefabricated muntin frame to the prefabricated metallic spacer frame. It has been known to bond the muntin frame to the metallic spacer frame by driving screws or nails from the outside into plastic end pieces provided on the ends of the muntins. This way of proceeding results, however, in reduced quality of the insulating glass pane because the pierced points of the spacer frame create an increased risk of diffusion of water vapor.

EP 0 857 847 B1 discloses an insulating glass pane having a thermoplastic spacer that is extruded directly onto one of the two glass panels of the insulating glass pane. A prefabricated muntin frame can then be positioned in the area enclosed by the spacer and can be connected with the spacer by displacement of end pieces slidably are arranged on the muntins, relative to the spacer until they engage the latter. Given the fact that the spacer is still soft and sticky in that phase, the force exerted on the spacer during that operation must be very small so as to not deform the spacer. EP 0 857 847 B1 therefore describes cutting edges provided on the end pieces that are capable of penetrating easily into the soft spacer. Positioning of the muntin frame in the area enclosed by the spacer is rather difficult. Incorrect positioning will deform the spacer, being still soft, and cannot be reversed. At the same time, the risk of incorrect positioning is high as muntin frames normally are instable loose structures that gain stability only by their connection with the spacer.

From GB 2 242 699 A it has been known, in connection with an insulating glass pane using a spacer made from a thermoplastic solid material that is prefabricated in the form of a rope and that may contain a metal strip for stiffening purposes, to use a muntin frame that is bonded to the inner side of the spacer via foot pieces. The foot pieces are movably attached to the ends of the muntin and comprise a base plate that is moved against and bonded to the inside of the spacer once the muntin frame has been positioned in the space enclosed by the spacer. This way of proceeding is likewise expensive and troublesome, for the reasons outlined before, and the bonding operation is difficult because pressure exerted upon the spacer must be kept small as otherwise the spacer would be deformed, especially would be caused to tilt.

Now, it is the object of the present invention to provide an insulating glass pane which is especially well suited for the installation of muntins, while avoiding the before-mentioned disadvantages and without jeopardizing the tightness of the insulating glass pane.

This object is achieved by an insulating glass pane having the features defined in Claim 1. Methods for the production of such an insulating glass pane are described in Claims 24 and 25. Advantageous further developments of the invention are the subject-matter of the sub-claims.

In the insulating glass panes according to the invention, two separate glass panels are kept at a distance from one another by a spacer, formed from a sectional bar,

comprising a wall that delimits the inner space of the insulating glass pane, having an inner side, an outer side opposite the inner side and two flanks;

wherein the inner side and the outer side of the sectional bar extend from one flank to the opposite flank;

a drying agent is provided in combination with the spacer;

a gap is provided on both sides of the spacer, between the latter and the two glass panels, the gap being sealed by a sealing compound that adheres to the spacer and to the glass panels; and

one or more muntins are fitted in the spacer and are anchored directly or indirectly on or in a compound, especially a sealing compound that adheres to the inner side of the spacer, without however piercing the compound fully up to inner side of the sectional bar, the compound preferably containing a drying agent.

This arrangement provides substantial advantages:
The sealing compound, which preferably consists of a thermoplastic material, can be applied on the spacer in soft and sticky condition and need not contribute itself to the dimensional stability of the spacer, being supported on the spacer which latter is formed from a sectional bar.

When anchoring the muntins on the spacer a substantially higher force can be exerted than in the case of a spacer formed by applying a thermoplastic rope on a glass panel, without any detrimental effects for the form of the spacer, as the sealing compound used for anchoring the muntins is firmly supported on the spacer formed from a sectional bar.
As the spacer is made from a sectional bar, it can be prefabricated as it has sufficient stability of its own for being handled independently of the glass panel.
One or more muntins can be connected with the spacer while it is not yet placed on a glass panel.
There is no need for separate fastening means, such as screws or nails, which normally are used for fitting muntins in metallic spacers. The sealing compound may directly serve as fastening means.
The sealing compound simultaneously contributes substantially toward sealing and, thus, toward increasing the service life of the insulating glass pane, and this especially when it extends from the one glass panel to the other glass panel, over the entire inner surface of the spacer, which is preferred.
The muntins can be anchored by merely pressing the muntin ends, or the separate foot pieces provided for the muntin ends, onto or into the sealing compound, without however penetrating the compound fully up to the inner,side of the sectional bar, so that the sealing effect of the sealing compound is maintained.
The foot pieces can be given a large format and can be pressed firmly into the sealing compound so that efficient anchoring will be achieved by a large-format bond on the one hand and the strong impression on the other hand. This is rendered possible by the sectional bar, which may be regarded as being rigid, that supports the sealing compound. Given the fact that the muntins can be fitted in the spacer while it is not yet been bonded to a glass panel, the outer sides of the spacer always can be supported on a solid support over their full lengths while the foot pieces for the muntins are being pressed into the sealing compound. The pressure applied may be so high that even when the foot pieces are provided with a plate, by which they are placed on the sealing compound, the foot pieces can be pressed into the sealing compound to such a degree that not only an adhesive bond but also a form-locking connection is achieved between the sealing compound and the foot piece. Such a form-locking connection can be further facilitated by giving the plate recesses and/or passages in which any displaced compound can be accommodated.

Conveniently, the foot pieces are provided with projecting connection means. The connection means establish the connection with the muntin, which normally is hollow. To this end, an adapter that is conveniently fitted in the muntin is fixed in the hollow end of the muntin for receiving the connection means, which projects from the foot piece, by a frictional connection, the connection means being a bar in the simplest of all cases. Connecting the foot piece with the adapter by simple insertion or by snapping-in is preferred. Preferably, the foot piece is provided with a plate, the connection means being arranged so as to project from that plate on the side of the plate opposite the sealing compound.

Using an adapter provides the advantage that the adapter may always have the same configuration for muntins of various cross-sectional shapes, as regards the support for the connection means projecting from the plate of the foot piece. The same foot pieces can then be fitted for different muntins, which is an advantage in terms of economic and rational frame production. The connection means provided on the adapter for connection with the foot piece may have various configurations. They may engage a connection means formed on the foot piece. Or the connection means formed on the foot piece may engage the adapter in which case the connection means may be provided with a recess as a connection means; that solution is preferred.

Especially in cases where the sealing compound applied on the inner side of the spacer extends from the primary sealing compound on the one flank of the spacer to the primary sealing compound on the other flank, any untightness occurring in the spacer will affect the sealing of the insulating glass pane either not at all or to a lesser degree. This is different for insulating glass panes of conventional structure where any untightness, for example pores or cracks or gaps, which may occur especially in the area of corners and in the area of the joint between the ends of a sectional bar from which the spacer is formed, will lead to disastrous consequences as conventional secondary sealing compounds, which are the only ones available in the prior art to cover such untight points in the spacer, cannot possibly prevent diffusion of water vapor to the degree necessary to achieve a service life of several years for the insulating glass pane.

If the sealing compound containing a drying agent is applied on the inner side of the sectional bar, it is possible to lower the quality demands placed on the sectional bars from which the spacers are formed because the sectional bars then have to perform a mechanical function only, namely the function of keeping the glass panels of the insulating glass pane at their predefined spacing under their typical conditions of use and the typical strains, and to combine with one or more sealing compounds. It is thus possible to use extremely low-cost sectional bars, which can be optimized for minimum heat transfer. Even foamed sectional bars may be used that distinguish themselves by especially efficient thermal insulation combined with good mechanical stability.

The invention is suited for spacers made from the most different materials and having many different cross-sectional shapes. Especially, the invention may be implemented using all conventional sectional bars that are commonly used for frame-like spacers, including the very usual box-shaped hollow steel or aluminum sectional bars, and also including metal or plastic sectional bars of U-shaped or C-shaped cross-section or metal sectional bars of the kind known, for example, from DE 202 16 560 U1. The use of hollow-section plastic bars is especially preferred.

The sealing compound containing a drying agent that extends from the one glass panel to the other glass panel can be suitably selected to fulfill all the functions the primary sealing compound fulfills in a conventional insulating glass pane: It may act as a primary seal providing a barrier to water vapor. It may also serve as a mounting aid during assembly of the insulating glass pane, in that it produces a provisional compound structure between the spacer and the two glass panels by bonding. And due to the incorporation of the drying agent, it has the additional capability of absorbing water vapor.

The primary sealing compound may at the same time form the basis for the sealing compound containing a drying agent. The two compounds may also conform one with the other. In that case, the sealing compound containing a drying agent may consist of the same thermoplastic material with integrated drying agent matrix from which the thermoplastic spacer is formed in TPS® insulating glass panes. That material is well suited for purposes of the invention. It may also be used between the glass panels of the insulating glass pane and the flanks of the spacer, instead of a sealing compound that does not contain a drying agent. Further, it is an advantage if a primary sealing compound, for example a polyisobutylene, is used as a basis for the sealing compound containing a drying agent and if the drying agent is concentrated in the sealing compound that faces the inner space of the insulating glass pane, and if the sealing compound, which is applied to the flanks of the spacer, is given a low content of drying agent or is made absolutely free from any drying agent. It is not necessary to distribute the drying agent in the sealing compound over the full width and length of the inner side of the sectional bar. Rather, the drying agent may be concentrated for example in a strip-like area narrower than the inner side of the sectional bar.

The sectional bar can be coated before being formed into the frame-like spacer. This then allows a very rational linear method of working, with a minimum of mechanical input.

The combination of sealing compound containing a drying agent on the one hand and primary sealing compound on the other hand is most conveniently applied on the inner side of the spacer over a width greater than the width of the spacer so that it will also cover the flanks and will be compressed, as the glass panels are pressed together, and come to adhere to the glass panels over a certain area. In order to produce such compression it is not necessary for the sealing compound containing a drying agent to adhere to the full surface of the inner side of the spacer. Rather, the combination of sealing compound containing a drying agent and primary sealing compound is preferably applied on the spacer, or on the sectional bar forming the spacer, in such a way that its inner side, facing the inner space of the insulating glass pane, and an additional strip of the flank will be covered. This guarantees that when the glass panels and the spacer are pressed together, the combination of the sealing compound containing a drying agent and the primary sealing compound will be subjected, at least in the area of the flanks, to sufficient pressure for bonding them without any gaps to the spacer flanks on the one side and the glass panels on the other side. Thus, the combination of the sealing compound containing a drying agent and the primary sealing compound produces at least a temporary compound structure from the glass panels and the spacer. If necessary, the compound structure is completed by a secondary sealing compound. The latter may extend without any interruption from the one glass panel over the outside of the spacer to the other glass panel. In order to produce the necessary permanent mechanical compound structure, it will however be sufficient if the glass panels are connected only indirectly by the secondary sealing compound. This can be achieved by applying a secondary sealing compound in the form of two separate ropes, one of them connecting the spacer with the one glass panel and the other one connecting the spacer with the other glass panel. This reduces the quantity of secondary sealing compound consumed and also the heat transfer in the area of the spacer.

The sectional bars from which the spacers are made may consist of conventional metallic hollow sectional bars. Sectional bars made from a plastic material are preferred because they allow sufficient mechanical stability, a low heat transfer coefficient and low cost to be achieved at one and the same time. The appearance of the sectional bar need not be taken into account considering that the bar will anyway not be visible after installation in the insulating glass pane.

Suitable cross-sectional shapes of the sectional bars from which the spacers are made are above all box-shaped hollow sections and solid sections. In the simplest of all cases the sectional bar has a rectangular cross-section of the least possible height with a view to keeping the cost of material and the heat transfer coefficient as low as possible. The minimum height is selected to ensure that the required compression strength and safety from tilting must be guaranteed for the spacer legs and that the primary sealing compound, or the combination of the sealing compound containing a drying agent and the primary sealing compound, must provide sufficient resistance to diffusion of water vapor into the insulating glass pane. Useful results are already obtained with a sectional bar 4 mm high.

An advantageous way of using a solid section instead of a hollow section consists in making the sectional bar from a foamed plastic material that combines sufficient mechanical stability with a low heat transfer coefficient and low cost.

According to another solution, the spacer is formed from sectional bars where the bar has a U-shaped cross-section but where the back, instead of forming the outside as in the prior art known from U.S. Pat. No. 6,470,561 B1, forms the inside of the spacer. If not only the primary sealing compound, or part of the combination of the primary sealing compound and the sealing compound containing a drying agent, but also the secondary sealing compound are applied on the flanks of such a U-shaped sectional bar, as provided by the invention, then the inner space of the U section may remain completely free from any secondary sealing compound on the outside of the spacer. Subsequent sealing of the insulating glass pane by application of sealing compound, especially of primary sealing compound, may then be required only at the corners of the spacer, if at all.

In order that the points where the muntins are to be anchored will be found easily, the surface of the compound containing a drying agent can be marked at the respective points, for example by a corresponding impression or by means of an ink jet printer.

In the case of an insulating glass pane according to the invention with rectangular contour, the spacer may be formed from four sectional bars that are connected one with the other by connector elements that are bent off at a right angle. One then has to ensure that the primary sealing compound, or a combination of the compound containing a drying agent and the primary sealing compound, is applied in the corner areas without any gaps. This is achieved more easily when the corners of the spacer are formed by bending of a sectional bar rather than by connecting elements. Accordingly, that solution is preferred for purposes of the invention. Bending metallic hollow sections or metallic U-sections to form a frame-like spacer for insulating glass panes is known in the art. But sectional bars made from a plastic material can also be bent into a frame-like spacer. A corresponding example is disclosed in DE 10 2004 005 354 A1 and in my German Patent Application DE 10 2005 002 284 “Spacer for insulating glass panes and method for production thereof”, to which reference is herewith made.

Once the spacer has been coated with a combination of a compound containing a drying agent and a primary sealing compound and has been assembled with the muntins already fitted, it is attached to a first glass panel so as to adhere to the latter in an area adjacent the edge of the glass panel. Thereafter, a second glass panel is attached to the spacer, in parallel to the first glass panel, so that the spacer will adhere to the second glass panel as well. The half-finished insulating glass pane assembled in this way is then compressed to its specified thickness. The spacer can be attached manually or mechanically. Devices suited for this purpose are known in the art. And the processes of assembling and compressing the insulating glass pane are also known in the art. In cases where the insulating glass pane is assembled to a structural unit only temporarily by application of the compound containing a drying agent and/or the primary sealing compound, the spacer is finally bonded to the two glass panels by additionally applying a curable secondary sealing compound. This can be effected, just as in the prior art, by applying the secondary sealing compound on the outside of the spacer, without any interruption from the one glass panel to other glass panel—see for example DE 28 16 437 C2. According to another method, two separate ropes of the secondary sealing compound are extruded into two gaps formed between the spacer and the two adjacent glass panels, as disclosed for example by U.S. Pat. No. 5,439,716 A. Finally, there is also the possibility to apply a secondary sealing compound on the two flanks of the hollow-section strip, in an area adjacent the primary sealing compound, before the spacer is fitted between the two glass panels.

Certain embodiments of the invention are illustrated in the attached drawings. Identical parts, or parts corresponding one to the other, are identified by the same reference numerals in the drawings. Further features and advantages of the invention will become apparent from the description of the examples.

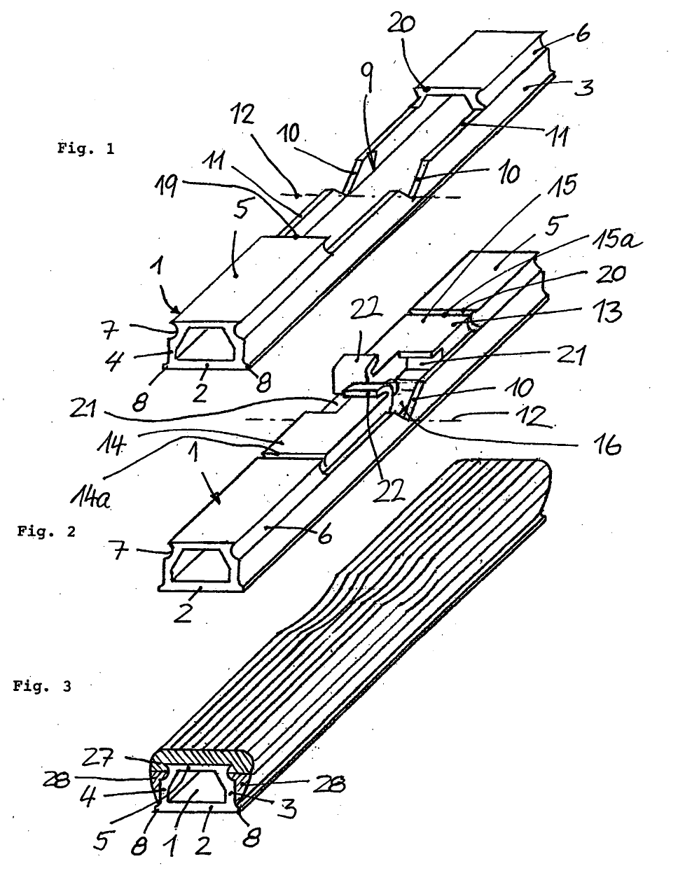

FIG. 1 shows an oblique view of a portion of the hollow-section bar that comprises a recess for forming a rectangular corner;

FIG. 2 shows a view of the hollow-section strip similar to FIG. 1, after insertion of an angle piece which is still in its straight configuration;

FIG. 3 shows an oblique view of the hollow-section bar of FIG. 2 after it has been coated with a sealing compound and a bonding compound;

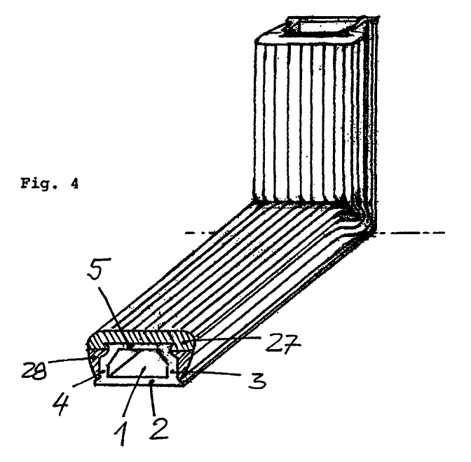

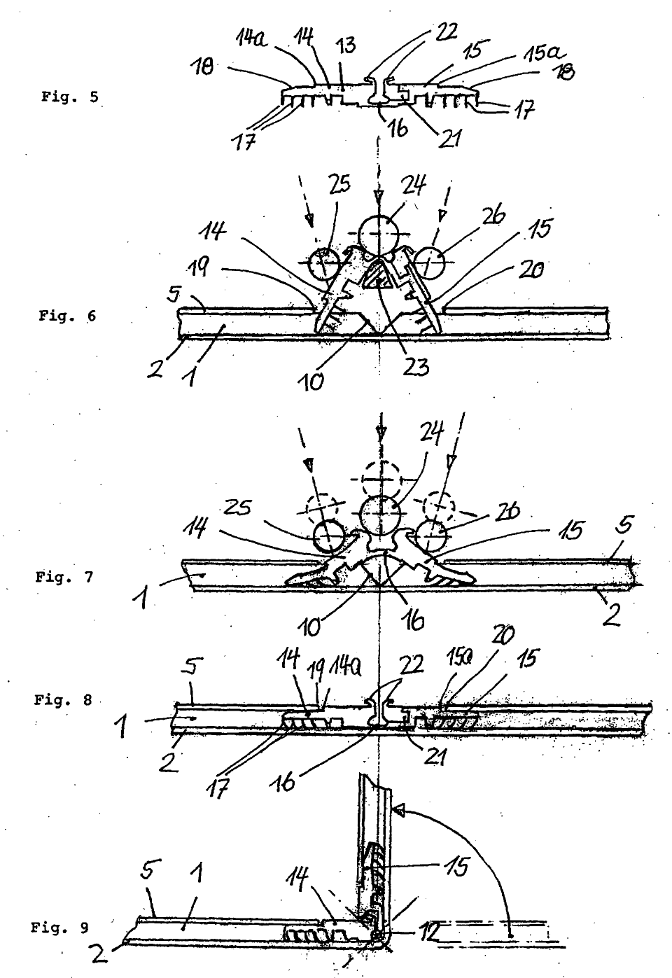

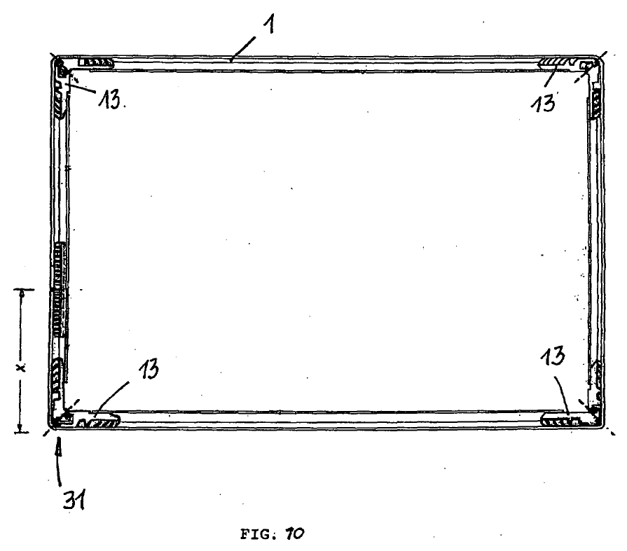

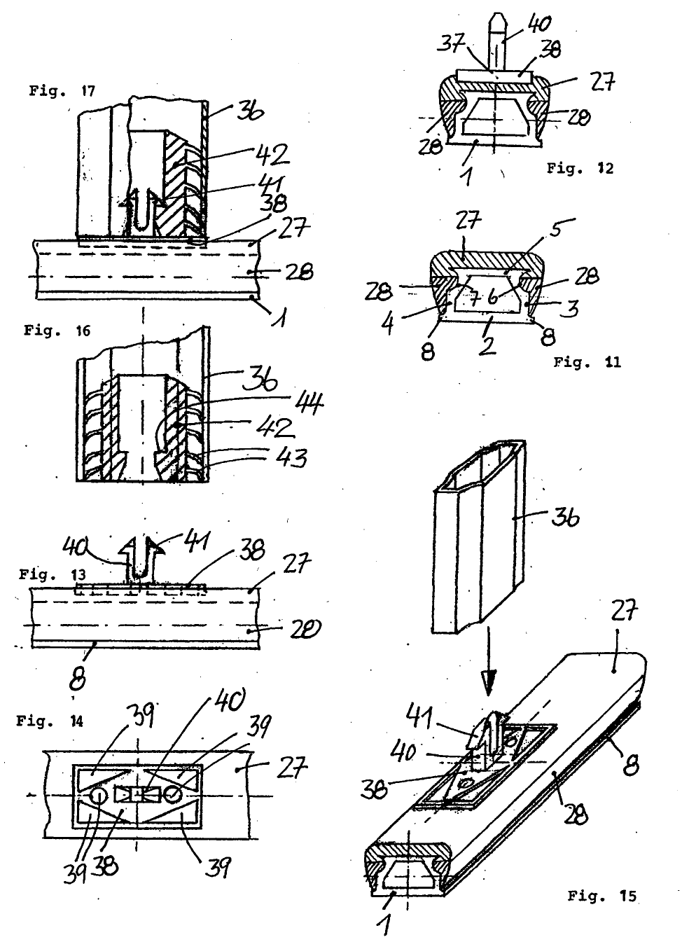

FIG. 4 shows the hollow-section bar of FIG. 3 after folding of a rectangular corner;

FIG. 5 shows a side view of the corner angle of FIG. 3;

FIGS. 6 to 8 show, by way of a longitudinal cross-section through the hollow-section bar, how the angle piece of FIG. 9 can be fitted in the hollow-section bar illustrated in FIG. 1;

FIG. 9 shows the process of forming a corner in the hollow-section bar illustrated in FIG. 8;

FIG. 10 is a diagrammatic longitudinal cross-section through the hollow-section bar showing a frame-like spacer formed with the aid of angle pieces;

FIG. 11 shows a cross-section through a coated hollow-section bar according to FIG. 3;

FIG. 12 is a representation similar to that of FIG. 11, showing the coated hollow-section bar with a foot piece for a muntin anchored on the bar;

FIG. 13 shows a side view of the portion of the hollow-section bar provided with the foot piece according to FIG. 12;

FIG. 14 shows a top view of the portion of the hollow-section bar with foot piece according to FIG. 13;

FIG. 15 shows an oblique view of the portion of a hollow-section bar according to FIG. 14, during the operation of delivery of the muntin;

FIG. 16 shows a longitudinal section through the lower end of the muntin according to FIG. 15;

FIG. 17 shows a longitudinal section through the lower end of a muntin according to FIG. 15, after it has been fitted on the foot piece;

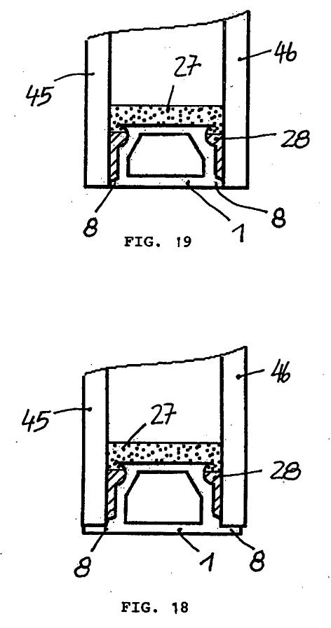

FIG. 18 shows a cross-section through a marginal portion of an insulating glass pane with a spacer according to FIG. 11; and

FIG. 19 shows a modification of FIG. 18.

FIG. 1 shows a section of a hollow-section bar 1 having an outer wall 2, two flanks 3 and 4 and an inner wall 5 parallel to the outer wall 2. A groove 6 or 7, respectively, is provided at the transition between the flanks 3, 4 and the inner wall 5. The outer wall 2 projects beyond the flanks 3, 4 on both sides. The projecting part 8 of the outer wall 2 either can determine the spacing between two glass panels that are to be assembled to an insulating glass pane with a spacer formed from a hollow-section bar 1 fitted between the panels (FIG. 19), or can serve to be applied to the edges of the glass panels (FIG. 18). Preferably, the hollow-section bar 1 is made from a plastic material and may be produced as an extruded profile.

At the points of the hollow-section bar 1 where the corner is to be formed a recess 9 is provided in the hollow-section bar 1 that extends from the inner wall 5 to and into the flanks 3 and 4. Provided in the flanks 3 and 4 are two portions 10 of the recess 9, arranged congruently one opposite the other, that have the shape of a rectangular miter cut the point of which is located at the level of the inside of the outer wall 2 and determines the location of the bending axis 12 about which the corner is to be bent. On both sides of the miter cuts in the flanks 3 and 4, the inner wall 5, including the grooves 6 and 7, has been removed over a predefined length and over its full width. The lengths of the portions 11 of the recess 9 in the inner wall 5 preferably are selected to conform one with the other.

Prior to bending of a rectangular corner in the hollow-section bar 1, a foldable angle piece 13 is inserted into the recess 9; in FIG. 2 the angle piece is already fitted in the hollow-section bar 1, with the angle piece 13 extending a certain distance below the inner wall 5 on both sides of the recess 9—which is not visible in FIG. 2.

FIG. 5 shows a side view of the fitted angle piece 13 according to FIG. 2. The angle piece 13 consists of two limbs 14 and 15 of equal length that are connected one with the other via a foil hinge 16 provided on the outside of the angle piece 13. The term outside of the angle piece 13 relates to that side which faces the outer wall 2 of the sectional bar 1 when the angle piece 13 is fitted in the hollow-section bar 1. The two limbs 14 and 15 are provided with flexible ribs 17, directed toward the outer wall 2 of the hollow-section bar, that project a little beyond the foil hinge 16. The inside of the limbs 14, 15 is flat—except for an inclined lead-in portion 18 at the tips of the limbs 14, 15—and extends in parallel to the outside of the foil hinge 16 in the straight condition of the angle piece 13. The height of the limbs 14 and 15 is selected and adapted with respect to the clear height of the hollow-section bar 1 in such a way that in its straight condition the angle piece 13 is in contact with the outer wall 2 by its foil hinge 16 and with the inside of the inner wall 5 by the side of its limbs 14 and 15 opposite the foil hinge 16, as illustrated in FIG. 8. Given the fact that the ribs 17 project a little beyond the outside of the foil hinge 16 they are bent off a little in the fitted position of the angle piece 13, with the effect that a tight fit of the limbs 14, 15 is achieved between the outer wall 2 and the inner wall 5 of the hollow-section bar 1.

On the side of the limbs 14 and 15 that faces away from the foil hinge 16 there is formed a stop 14a and 15a, respectively, by increasing the height of the limbs 14 and 15 in the neighborhood of the foil hinge 16 in steps by approximately the thickness of the inner wall 5. The stops 14a and 15a face the two edges 19 and 20 that delimit the portions 11 of the recess 9 in the inner wall 5 and that extend from the one flank 3 to the opposite flank 4, transversely to the longitudinal direction of the hollow-section bar 1. The position of the stops 14a and 15a is adjusted to the length of the recess 9 so that the stops 14a and 15a come to lie closely before the edges 19 and 20. This centers the middle of the foil hinge on the specified bending axis 12.

Each of the two limbs 14 and 15 is provided, on one half of its width in the neighborhood of the foil hinge 16, with a recess 21 that is open on its side facing the opposite limb 15, 14. On the other half of their width, the limbs 14 and 15 are each provided with a hook 22 in the neighborhood of the foil hinge 16. The two hooks 22 face away from each other, namely in the direction of the tips of the limbs 14 and 15. The hook 22 in each limb 14, 15 is arranged opposite the recess 21 in the other limb 14, 15. The configuration and arrangement of the hooks 22 are such that the hooks snap into the oppositely arranged recess 21 when the two limbs 14a, 15a are pivoted about the foil hinge 16. Due to their form-locking engagement in the recesses 21, the two limbs 14 and 15 are thus positioned and fixed in place at a right angle one relative to the other. Preferably, the design of the foil hinge 16 is such that in the bent condition a restoring force is produced that has the effect to urge the hooks 22 against the wall of the recess 21 thereby additionally stabilizing the corner.

The angle piece illustrated in FIG. 5 can be fitted in the hollow-section bar 1 in the way illustrated in FIGS. 6 and 7. For this purpose, the angle piece 13 is clamped by its foil hinge 16 between a wedge-shaped abutment 23 and a finger 24. The two limbs 14 and 15 are pivoted against the abutment 23 by two further fingers 25 and 26. The tips of the limbs 14 and 15 then have been approached one to the other sufficiently for being introduced into the recess 9 (FIG. 6). Now, the abutment 23 is removed and the fingers 24, 25 and 26 are approached to the hollow-section bar I in the direction indicated by the three arrows in FIG. 7. As a result, the angle piece 13 is pressed into the hollow-section bar 1, while being simultaneously spread, during which process the limbs 14 and 15 are bent temporarily by the fingers 25 and 26 (FIG. 7). Introduction of the angle piece 13 is complete when the angle piece is fitted in the hollow-section bar 1 in flat condition. The sections of the limbs 14 and 15 that project beyond the stop 14a and 15a then lie below the inner wall 5, as illustrated in FIG. 8.

Once an angle piece 13 has been inserted in straight condition into each of the recesses 9, for all the four corners of the spacer, the hollow-section bar 1, still occupying its flat position, is continuously coated with a sealing compound 27 on that side of its inner wall 5 that faces the inner space of the insulating glass pane, hereinafter also described as inner side, and with a secondary sealing compound 28, capable of curing, on the flanks 3 and 4. This is effected by moving the hollow-section bar 1 linearly past one or more nozzles from which the sealing compound 27 and the secondary sealing compound 28 can be extruded in a controlled way in synchronism with the movement of the hollow-section bar 1. One way of carrying out that process is described, for example, by DE 10 2004 020 883, to which reference is herewith expressly made. The sealing compound 27 is intended to subsequently prevent diffusion of water vapor into the insulating glass pane in which the spacer formed from the hollow-section bar 1 is to be installed. The sealing compound 27 consists, for example, of a material based on polyisobutylene; in the first line it serves as a primary sealing compound and, in the second line, it preferably contains a drying agent in powder form. The sealing compound 27 covers the entire inner wall 5 and extends laterally beyond the latter so that it even projects beyond the line of the flanks 3 and 4 and fills the grooves 6 and 7 at least in part. The secondary sealing compound 28, which preferably is a reactive hot-melt, is applied on the flanks 3 and 4 closely adjacent the sealing compound 27, preferably using nozzles that are operated shortly after the nozzles used for applying the sealing compound 27. This provides the advantage that the sealing compound 27, that has been applied before, serves as a limiting line for the application of the secondary sealing compound 28 and that application of the sealing compound 27 can be controlled independently of the application of the secondary sealing compound 28, which may be of advantage with respect to sealing compounds having different properties, such as ductility and compressibility.

Once the hollow-section bar 1 has been coated with the sealing compound 27 and the secondary sealing compound 28 (FIG. 3) it can then be bent or folded at the points provided for this purpose, for forming the corners of the frame-like spacer during which process the restoring force provided by the foil hinge has to be overcome. This is illustrated in FIG. 9 by way of an uncoated hollow-section bar 1 in order to show how the hooks 22 engage the recesses 21, thereby fixing the limbs 14 and 15 one relative to the other at a right angle. Due to the form-locking engagement of the hook 22 in the associated recess 21, no angle greater than 90 degrees can be formed between the two limbs 14 and 15.

Once the hooks 22 have snapped into the associated recesses 21, stops acting between the limbs 14, 15 will prevent any further reduction in size of the angle. In bending or folding of the corner any excessive amounts of sealing compound 27 and secondary sealing compound 28 are in part pressed into cavities existing in the area of the corner and are in part displaced onto the flanks 3 and 4, as illustrated in FIG. 4. This is desirable because it contributes toward sealing the spacer in the area of the corners. When the spacer is subsequently installed in an insulating glass pane, any excessive amounts of sealing compound 27 and of secondary sealing compound 28 on the flanks 3 and 4 are pressed against the flanks 3 and 4 and into the corner by the glass panels, which once more favors the formation of a hermetically tight corner.

Once all the four corners have been bent, the beginning and the end of the hollow-section bar 1 are positioned one opposite the other and are connected one with the other by a straight connecting element 35 that is introduced into one end and then into the other end of the hollow-section bar 1 prior to the bending or folding operation. The inner structure of a frame-shaped spacer with corner angles is illustrated in FIG. 10 where the coating of sealing compound 27 and a secondary sealing compound 28 are not shown for reasons of clarity.

A spacer formed from a hollow-section bar 1, where the inner wall 5 is coated with a sealing compound 27, as illustrated for example in FIG. 11, is particularly well suited for installation of one or more muntins 36. This is effected by pressing a foot piece 37 into the sealing compound 27, without however piercing the layer of sealing compound 27 present on the inner wall 5, so that a full-surface coating is maintained on the inner wall 5, which is an advantage with respect to the sealing of the insulating glass pane from diffusion of water vapor. As the foot piece 37 is pressed into the compound a corresponding quantity of sealing compound 27 is displaced, rising along its edges, so that sort of an interlinking is formed between the sealing compound 27 and the foot piece 37. As sealing compounds such as polyisobutylene are sticky, the desirable adhesive effect is added to the interlinking between the sealing compound 27 and the foot piece 37. The interlinking between the sealing compound 27 and the foot piece 37 is especially efficient when the foot piece 37 comprises a plate-38 provided with passages 39, as illustrated in FIG. 14. In that case, the sealing compound 27 is also displaced into the passages 39, whereby an especially intimate interlinking with the foot piece 37 is obtained. Mounted on the plate 38 is a connection means 40 in the form of a two-limbed fork with barbs 41 directed in opposite directions. The fork 40 can be snapped into a matching receiving element 42 fitted in the end of the hollow muntin 36. The receiving element 42 may be a molded plastic part which has an outer contour adapted to the inner contour of the muntin 36 and which is provided with ribs 43 which are bent off toward the end of the muntin 36, as the receiving element 42 is introduced into the muntin 36, and which therefore oppose increased resistance to an attempt to pull off the muntin 36. The inner contour of the receiving element 42 is the same for all kinds of muntins 36. This provides the advantage that one and the same foot piece 37 will be suited for all sorts of muntins 36, which may differ in cross-section. The receiving element 42 serves as adapter in this case.

The receiving element 42 is provided with an undercut 44 that can be resiliently engaged by the barbs 41.

During the process of coating the straight hollow-section bar 1 by a continuous process the coating may be marked at the points where a muntin 36 is to be located, for example using an ink jet printer. The foot piece 37 can then be pressed into the sealing compound manually at the points so marked before the hollow-section bar 1 is bent and while it is still lying on a stable support. Alternatively, the foot pieces 37 can be placed automatically using a numerically controlled handling device; in that case, it is not necessary to mark the points where the foot pieces 37 are to be placed later. For example, the muntins 36 can be fitted on the foot pieces 37 shortly before the spacer is finally closed—see FIGS. 15 and 16.

FIG. 18 shows a cross-section through part of an insulating glass pane consisting of two separate glass panels 45 and 46 which enclose between them a frame-shaped spacer formed from a hollow-section bar 1—as illustrated in FIG. 11—that has been coated before with a sealing compound 27 and a curable sealing compound 28. The hollow-section bar 1 is aligned flush with the edges of the glass panels 45 and 46, with the projecting parts 8 of the outer wall 2 covering the edges of the glass panels 45 and 46 in intimate contact with the latter so as to protect them from splintering.

The insulating glass pane illustrated in FIG. 19 differs from the insulating glass pane illustrated in FIG. 18 in that the projecting parts 8 of the outer wall 2 of the hollow-section bar 1 do not serve to protect the edges of the two glass panels 45 and 46. Instead, the projecting parts 8 of the outer wall 2 are positioned between the two glass panels 45 and 46 thereby defining the spacing and the minimum thickness of the coating on the flanks 3 and 4 of the hollow-section bar 1. The outer wall 2 of the hollow-section bar 1 is aligned flush with the edges of the glass panels 45 and 46 so that no marginal gap remains between the panels that would have to be sealed later.

### List of Reference Numerals:

1. Hollow-section bar
2. Outer wall
3. Flank
4. Flank
5. Inner wall
5a. Side of 5 (inner side) facing the inner space of the insulating glass pane
6. Groove
7. Groove
8. Projecting part of 2
9. Recess
10. Portions of the recess in 3,4
11. Portions of the recess in 5
12. Bending axis
13. Angle piece
14. Limb of 13
14a. Stop
15. Limb of 13
15a. Stop
16. Foil hinge
17. Ribs
18. Inclined lead-in portion
19. Edge
20. Edge
21. Recess
22. Hook
23. Abutment
24. Finger
25. Finger
26. Finger
27. Sealing compound, primary sealing compound
28. Secondary sealing compound
35. Straight connection element
36. Muntin
37. Foot piece
38. Plate
39. Passages in 38
40. Connection means
41. Barb
42. Receiving element, adapter
43. Ribs
44. Undercut
45. Glass panel
46. Glass panel

1. Insulating glass pane wherein
two separate glass panels are kept at a distance from one another by a spacer, formed from a sectional bar, comprising a wall that delimits the inner space of the insulating glass pane and has an inner side, an outer side or outer wall opposite the inner side and two flanks;
the inner side and the outer side or outer wall of the sectional bar extend from one flank to the opposite flank;
a drying agent is provided in conjunction with the spacer;
a gap is provided on both sides of the spacer, between the latter and the two glass panels, the gap being sealed by a secondary sealing compound that adheres to the spacer and to the glass panels;
and one or more muntins are fitted in the spacer,
wherein a further compound, especially a primary sealing compound, that adheres to the spacer, is arranged on the inner side of the spacer and that the muntins are anchored directly or indirectly on or in the further compound without piercing the further compound fully up to the inner side of the sectional bar.

2. The insulating glass pane as defined in claim 1, wherein the further compound adhering to the inner side of the spacer contains a drying agent.

3. The insulating glass pane as defined in claim 1, wherein the muntins are connected with separate foot pieces which are anchored directly on or in the further compound that adheres to the inner side of the spacer, without piercing the further compound fully up to inner side of the sectional bar.

4. The insulating glass pane as defined in claim 2, wherein the muntins or their foot pieces, respectively, are anchored in the compound adhering to the inner side of the spacer in form-locking engagement.

5. The insulating glass pane as defined in claim 4, wherein the foot pieces are provided with a projecting connection means that serves to connect the foot piece with the muntin.

6. The insulating glass pane as defined in claim 3, wherein the foot pieces are provided with a plate by means of which they are anchored on or in the further compound adhering to the inner side of the spacer, and that the plate comprises a connection means that projects from the plate.

7. The insulating glass pane as defined in claim 6, wherein the plate is provided with recesses and/or passages for accommodating the further compound that adheres to the inner side of the spacer.

8. The insulating glass pane as defined in claim 7, wherein the recesses and/or passages accommodate the further compound that adheres to the inner side of the spacer and that has been displaced by pressing the foot piece pinto the further compound.

9. The insulating glass pane as defined in any of the preceding claims in connection with claim 3, wherein the muntins are connected with their foot piece via an adapter.

10. The insulating glass pane as defined in claim 9, wherein the adapter is provided in the end of the muntin.

11. The insulating glass pane as defined in claim 10, wherein the adapter is fixed in the hollow end of the muntin.

12. The insulating glass pane as defined in claim 9, wherein adapters, adapted to muntins of various cross-sectional shapes, are provided with corresponding connection means for connection with foot pieces of identical configuration one to the other.

13. The insulating glass pane as defined in claim 5, wherein the connection means of the foot piece is an extension that engages an adapter according to any of claims 9 to 12 which connects the foot piece with a muntin.

14. The insulating glass pane as defined in claim 13, wherein the foot piece and the adapter are connected one with the other by simple insertion and/or by snapping-in.

15. The insulating glass pane as defined in claim 1, wherein the further compound adhering to the inner side of the spacer covers the entire inner side of the spacer to the extent it is not already covered by another sealing compound that has been applied onto the flanks and that may extend up to the inner side of the spacer.

16. The insulating glass pane as defined in claim 1, wherein the further compound adhering to the inner side of the spacer is applied tightly adjacent the other sealing compound that has been applied to the flanks of the spacer and adheres to the latter sealing compound.

17. The insulating glass pane as defined in claim 1, wherein the further compound adhering to the inner side of the spacer is interlinked with the spacer in form-locking engagement.

18. The insulating glass pane as defined in claim 1, wherein the sectional bar is made from a plastic material.

19. The insulating glass pane as defined in claim 1, wherein the sectional bar is a rectangle in cross-section.

20. The insulating glass pane as defined in claim 17, wherein the sectional bar has a hollow box section.

21. The insulating glass pane as defined in claim 18, wherein the sectional bar has a solid section instead of a hollow section.

22. The insulating glass pane as defined in claim 21, wherein the sectional bar consists of a foamed material.

23. The insulating glass pane as defined in any of the preceding claims, wherein the spacer is provided with corners that are formed by bending the sectional bar.

24. Method for producing an insulating glass pane wherein
two separate glass panels are kept at a distance from one another by a spacer, formed from a sectional bar, comprising a wall that delimits the inner space of the insulating glass pane and has an inner side, an outer side or outer wall opposite the inner side and two flanks;
the inner side and the outer side or outer wall of the sectional bar extend from one flank to the opposite flank;
a drying agent is provided in conjunction with the spacer;
a gap is provided on both sides of the spacer, between the latter and the two glass panels, the gap being sealed by a sealing compound that adheres to the spacer and to the glass panels;
and one or more muntins are fitted in the spacer,
and a further compound, especially a primary sealing compound, that adheres to the spacer, is arranged on the inner side of the spacer and that the muntins are anchored directly or indirectly on or in the further compound without piercing the further compound fully up to the inner side of the sectional bar,
the method comprising the steps of
(a) providing a sectional bar;
(b) applying the further compound, which preferably contains the drying agent, onto the sectional bar, namely on the side that later forms the inner side of the spacer; and
applying a sealing compound onto the flanks of the sectional bar;
(c) anchoring foot pieces for one or more muntins on or in the further compound that has been applied on the inner side of the sectional bar, without piercing it fully up to the inner side of the sectional bar;
(d) forming the coated sectional bar into a frame-shaped structure, mounting one or more muntins on the foot pieces and closing the frame-shaped structure to form a spacer, by connecting the ends of the sectional bar one with the other;
(e) attaching the spacer to a first glass panel so that it adheres to the latter in the neighborhood of the edge of the first glass panel;
(f) attaching a second glass panel to the spacer in parallel to the first glass panel (45) so that the spacer adheres to the second glass panel as well;
(g) compressing the two glass panels to the thickness specified for the insulating glass pane;
(h) connecting the spacer, if desired, with the two glass panels by application of a secondary sealing compound,
wherein the sequence in which the further compounds and the other sealing compound are applied onto the inner side can be exchanged or application may be effected simultaneously or in a way overlapping in time.

25. Method for producing an insulating glass pane, wherein
two separate glass panels are kept at a distance from one another by a spacer, formed from a sectional bar, comprising a wall that delimits the inner space of the insulating glass pane and has an inner side, an outer side or outer wall opposite the inner side and two flanks;
the inner side and the outer side or outer wall of the sectional bar extend from one flank to the opposite flank;
a drying agent is provided in conjunction with the spacer;
a cap is provided on both sides of the spacer, between the latter and the two glass panels, the cap being sealed by a sealing compound that adheres to the spacer and to the glass panels;
and one or more muntins are fitted in the spacer,
and a further compound, especially a primary sealing compound, that adheres to the spacer, is arranged on the inner side of the spacer and that the muntins are anchored directly or indirectly on or in the further compound without piercing the further compound fully up to the inner side of the sectional bar,
the method comprising the steps of
(a) providing a sectional bar;
(b1) applying the further compound, which preferably contains a drying agent, onto the sectional bar, namely on the side that later forms the inner side of the spacer; and
applying a primary sealing compound onto the flanks of the sectional bar;
(b2) applying a secondary sealing compound onto the flanks of the sectional bare;
(c) anchoring foot pieces for one or more muntins on or in the compound that adheres to the inner side of the sectional bar, without piercing it fully up to the inner side of the sectional bar;
(d) forming the coated sectional bar into a frame-shaped structure, mounting one or more muntins on the foot pieces and closing the frame-shaped structure to form a spacer, by connecting the ends of the sectional bar one with the other;
(e) attaching the spacer to a first glass panel so that it adheres to the latter in the neighborhood of the edge of the first glass panel;
(f) attaching a second glass panel to the spacer in parallel to the first glass panel (45) so that the spacer adheres to the second glass panel as well;
(g) compressing the two glass panels to the thickness specified for the insulating glass pane;
wherein the sequence in which the primary and the secondary sealing compounds and the further sealing compound, which preferably contains the drying agent, are applied can be exchanged or the application may be effected simultaneously or in a way overlapping in time.

26. The method as defined in claims 24, wherein the further compound used as the compound that preferably contains the drying agent, is a sealing compound which efficiently prevents water vapor from diffusing into the inner space of the insulating glass pane, especially one based on polyisobutylene or other primary sealing compounds commonly used for insulating glass panes.

27. The method as defined in claim 24, wherein a primary sealing compound applied on the flanks likewise contains a drying agent.

28. The method as defined in claim 24, wherein the further compound to be applied onto the inner side of the sectional bar, which contains the drying agent, and the other sealing compound are applied adjacent one another and so that the further compound containing the drying agent covers the entire inner side of the spacer to the extent it is not already covered by the other sealing compound.

29. The method as defined in claim 24, wherein the further compound, which preferably contains the drying agent, is applied so as to cover the entire inner side of the spacer and to extend even onto the flanks.

30. The method as defined in claim 29, wherein the further compound, which preferably contains the drying agent, simultaneously serves as the primary sealing compound.

31. The insulating glass pane as defined in claim 18, in which the sectional bar has a hollow box section.

32. The insulating glass pane as defined in claim 19, in which the sectional bar has a solid section instead of a hollow section.

33. The insulating glass pane as defined in claim 32 in which the sectional bar consists of a foamed material.

34. The insulating class pane as defined in claim 4, in which the foot pieces are provided with a plate by means of which they are anchored on or in the further compound adhering to the inner side of the spacer, and that the plate comprises a connection means that projects from the plate.

35. The method as defined in claim 25, in which the further compound used as the compound that preferably contains the drying agent, is a sealing compound which efficiently prevents water vapor from diffusing into the inner space of the insulating glass pane, especially one based on polyisobutylene or other primary sealing compounds commonly used for insulating glass panes.

36. The method as defined in claim 25, in which a primary sealing compound applied on the flanks likewise contains a drying agent.

37. The method as defined in claim 25, in which the further compound to be applied onto the inner side of the sectional bar, which contains the drying agent, and the other sealing compound are applied adjacent one another and so that the further compound containing the drying agent covers the entire inner side of the spacer to the extent it is not already covered by the other sealing compound.

38. The method as defined in claim 25, in which the further compound, which preferably contains the drying agent, is applied so as to cover the entire inner side of the spacer and to extend even onto the flanks.

39. The method as defined in claim 38, in which the further compound, which preferably contains the drying agent, simultaneously serves as the primary sealing compound.
